(19) United States
(12) Patent Application Publication
(10) Pub. No.: US 2012/0328872 A1
(43) Pub. Date: Dec. 27, 2012

(54) LAMINATE

(75) Inventors: Toyonari ITO, Tsukuba-shi (JP); Shohei AZAMI, Tsukuba-shi (JP); Changbo SHIM, Daejeon-shi (KR)

(73) Assignee: SUMITOMO CHEMICAL COMPANY, LIMITED, Tokyo (JP)

(21) Appl. No.: 13/524,691

(22) Filed: Jun. 15, 2012

(30) Foreign Application Priority Data
Jun. 22, 2011 (JP) 2011-138223

(51) Int. Cl. B32B 15/04

(52) U.S. Cl. 428/337

(57) ABSTRACT

A laminate including an insulating layer including one insulating base material or plural insulating base materials laid one upon another, the base material being obtained by impregnating a glass cloth having a thickness of 5 to 25 μm with a liquid crystal polyester; and a metal layer provided on one surface or both, surfaces of the insulating layer.

### BACKGROUND OF THE INVENTION

1. Field of the Invention

The present invention relates to a laminate.

2. Description of the Related Art

JP-T-2010-528149 discloses, as a laminate for electronic substrate material using a liquid crystal polyester, a laminate including (i) a liquid crystal polyester insulating base material (insulating layer) obtained by impregnating a sheet made of a glass fiber with a liquid composition containing a liquid crystal polyester, and removing a solvent, and (ii) a metal layer. This laminate has high rigidity and is excellent in dimensional stability at high temperature, but has a problem that repeated flexibility may sometimes become insufficient.

### SUMMARY OF THE INVENTION

An object of the present invention is to provide a laminate which is excellent in dimensional stability at high temperature and repeated flexibility.

The present invention relates to a laminate including: an insulating layer including one insulating base material or plural insulating base materials laid one upon another, the base material being obtained by impregnating a glass cloth having a thickness of 5 to 25 μm with a liquid crystal polyester; and a metal layer provided on one surface or both surfaces of the insulating layer.

### BRIEF DESCRIPTION OF THE DRAWINGS

FIG. 1 is a schematic sectional view illustrating an embodiment of a laminate of the present invention.

### DETAILED DESCRIPTION OF THE INVENTION

The laminate of the present invention is excellent in dimensional stability at high temperature since an insulating layer thereof includes a glass cloth impregnated with a liquid crystal polyester, and also the laminate is excellent in repeated flexibility since the glass cloth has a thickness of 5 to 25 μm. The above-mentioned “high temperature” means a temperature region of 200 to 250° C.

The liquid crystal polyester according to the present invention is preferably a liquid crystal polyester which exhibits mesomorphism in a molten state, and melts at a temperature of 450° C. or lower. The liquid crystal polyester may be a liquid crystal polyesteramide, a liquid crystal polyesterether, a liquid crystal polyester carbonate or a liquid crystal polyesterimide. The liquid crystal polyester is preferably a whole aromatic liquid crystal polyester using only an aromatic compound as a raw monomer.

Typical liquid crystal polyester includes the following liquid crystal polyesters:

(I) a liquid crystal polyester obtained by polycondensation (hereinafter referred simply to as “polymerization”) of an aromatic hydroxycarboxylic acid, an aromatic dicarboxylic acid, and at least one compound selected from the group consisting of an aromatic diol, an aromatic hydroxyamine and an aromatic diamine;
(II) a liquid crystal polyester obtained by polymerizing plural kinds of aromatic hydroxycarboxylic acids;
(III) a liquid crystal polyester obtained by polymerizing an aromatic dicarboxylic acid with at least one compound selected from the group consisting of an aromatic diol, an aromatic hydroxyamine and an aromatic diamine; and
(IV) a liquid crystal polyester obtained by polymerizing a polyester such as polyethylene terephthalate with an aromatic hydroxycarboxylic acid.

Herein, an aromatic hydroxycarboxylic acid, an aromatic dicarboxylic acid, an aromatic diol, an aromatic hydroxyamine and an aromatic diamine, each independently, may be partially or entirely converted into a polymerizable derivative thereof.

Examples of the polymerizable derivative of compounds having a carboxyl group, such as an aromatic hydroxycarboxylic acid and an aromatic dicarboxylic acid include a derivative (ester) in which a carboxyl group is converted into an alkoxycarbonyl group or an aryloxycarbonyl group, a derivative (acid halide) in which a carboxyl group is converted into a haloformyl group, and a derivative (acid anhydride) in which a carboxyl group is converted into an acyloxycarbonyl group.

Examples of the polymerizable derivative of compounds having a hydroxyl group, such as an aromatic hydroxycarboxylic acid, an aromatic diol and an aromatic hydroxylamine include a derivative (acylate) in which a hydroxyl group is converted into an acyloxyl group by acylation.

Examples of the polymerizable derivatives of compounds having an amino group, such as an aromatic hydroxyamine and an aromatic diamine include a derivative (acylate) in which an amino group is converted into an acylamino group by acylation.

The liquid crystal polyester preferably includes 30 to 50 mol % of a repeating unit represented by the following formula (1) (hereinafter, referred to as a “repeating unit (1)”), 25 to 35 mol % of a repeating unit represented by the following formula (2) (hereinafter, referred to as a “repeating unit (2)”), and 25 to 35 mol % of a repeating unit represented by the following formula (3) (hereinafter, referred to as a “repeating unit (3)”):

—O—Ar¹—CO— (1)

—CO—Ar²—CO— (2)

—X—Ar³—Y— (3)

—Ar⁴—Z—Ar⁵— (4)

wherein Ar¹ is a phenylene group, a naphthylene group, or a biphenylylene group; Ar² and Ar³ each independently represent a phenylene group, a naphthylene group, a biphenylylene group, or a group represented by the formula (4); X and Y each independently represent an oxygen atom or an imino group; Ar⁴ and Ar⁵ each independently represent phenylene group or a naphthylene group; Z is an oxygen atom, a sulfur atom, a carbonyl group, a sulfonyl group, or an alkylidene group; and one or more hydrogen atom(s) in Ar¹, Ar² or Ar³, each independently may be substituted with a halogen atom, an alkyl group, or an aryl group.

Examples of the halogen atom include a fluorine atom, a chlorine atom, a bromine atom and an iodine atom. Examples of the alkyl group include a methyl group, an ethyl group, a n-propyl group, an isopropyl group, a n-butyl group, an isobutyl group, a sec-butyl group, a tert-butyl group, a n-pentyl group, a n-hexyl group, a n-heptyl group, a 2-ethylhexyl group, a n-octyl group, a n-nonyl group and a n-decyl group. The number of carbon atoms is preferably from 1 to 10. Examples of the aryl group include a phenyl group, an o-tolyl group, a m-tolyl group, a p-tolyl group, a 1-naphthyl group and a 2-naphthyl group. The number of carbon atoms is preferably from 6 to 20.

In the case where the hydrogen atom is substituted with these groups, the number of groups, each independently, is preferably 2 or less, and more preferably 1, every group represented by Ar¹, Ar² or Ar³.

Examples of the alkylidene group include a methylene group, an ethylidene group, an isopropylidene group, a n-butylidene group and a 2-ethylhexylidene group. The number of carbon atoms is preferably from 1 to 10.

The repeating unit (1) is a repeating unit derived from an aromatic hydroxycarboxylic acid. The repeating unit (1) is preferably a repeating unit derived from p-hydroxybenzoic acid (repeating unit in which Ar¹ is a 1,4-phenylene group), or a repeating unit derived from 6-hydroxy-2-naphthoic acid (repeating unit in which Ar¹ is a 2,6-naphthylene group).

The repeating unit (2) is a repeating unit derived from an aromatic dicarboxylic acid. The repeating unit (2) is preferably a repeating unit derived from terephthalic acid (repeating unit in which Ar² is a 1,4-phenylene group), a repeating unit derived from isophthalic acid (repeating unit in which Ar² is a 1,3-phenylene group), a repeating unit derived from 2,6-naphthalenedicarboxylic acid (repeating unit in which Ar² is a 2,6-naphthylene group), or a repeating unit derived from diphenylether-4,4′-dicarboxylic acid (repeating unit in which Ar² is adiphenylether-4,4′-diyl group).

The repeating unit (3) is a repeating unit derived from an aromatic diol, an aromatic hydroxyl amine or an aromatic diamine. The repeating unit (3) is preferably a repeating unit derived from hydroquinone, p-aminophenol or p-phenylenediamine (repeating unit in which Ar³ is a 1,4-phenylene group), or a repeating unit derived from 4,4′-dihydroxybiphenyl, 4-amino-4′-hydroxybiphenyl or 4,4′-diaminobiphenyl (repeating unit in which Ar³ is a 4,4′-biphenylylene group).

The content of the repeating unit (1) in the liquid crystal polyester is preferably 30 mol % or more, more preferably from 30 to 80 mol %, still more preferably from 30 to 60 mol %, and particularly preferably from 30 to 50 mol %, based on 100 mol % in total of the repeating units (1), (2) and (3). The content of both repeating units (2) and (3) is preferably 35 mol % or less, more preferably from 10 to 35 mol %, still more preferably from 20 to 35 mol %, and particularly preferably from 25 to 35 mol %.

When the content of the repeating unit (1) becomes larger, heat resistance, strength and rigidity of the liquid crystal polyester are likely to be improved. However, when the content is too large, solubility in a solvent is likely to decrease.

The ratio (content of the repeating unit (2)/content of the repeating unit (3)) of the content of the repeating unit (2) to the content of the repeating unit (3) is preferably from 0.9/1 to 1/0.9, more preferably from 0.95/1 to 1/0.95, and still more preferably from 0.98/1 to 1/0.98.

The liquid crystal polyester, each independently, may include two or more kinds of the repeating units (1) to (3).

The liquid crystal polyester may include a repeating unit other than the repeating units (1) to (3), and the content thereof is preferably 10 mold or less, and more preferably 5 mol % or less, based on 100 mol % in total of all the repeating units included in the liquid crystal polyester.

From the viewpoint of the liquid crystal polyester having excellent solubility in a solvent, X and/or Y of at least a part of the repeating unit (3) are/is preferably imino group(s) (—NH—) (that is, a repeating unit derived from an aromatic hydroxyl amine and/or a repeating unit derived from an aromatic diamine are/is preferably included), X and/or Y of the entire repeating unit (3) are/is more preferably imino group(s) (—NH—).

Preferably, the liquid crystal polyester according to the present invention (i) includes 30 to 50 mol % of a repeating unit (1) in which Ar¹ is a 1,4-phenylene group or a 2,6-naphthylene group; (ii) includes 25 to 35 mol % of a repeating unit (2) in which Ar² is a 1,4-phenylene group, a 1,3-phenylene group or a 2,6-naphthylene group; and (iii) includes 25 to 35 mol % of a repeating unit (3) in which Ar³ is a 1,4-phenylene group, one of X and Y is an oxygen atom, and the other one is an imino group; based on 100 mol % in total of the repeating units (1), (2) and (3). Particularly preferably, the liquid crystal polyester particularly preferably satisfies all of these requirements (i), (ii) and (iii).

The liquid crystal polyester is preferably produced by melt polymerization of raw monomers to obtain a polymer (hereinafter referred to as a “prepolymer”), followed by solid-phase polymerization of the prepolymer. It is possible to produce a high-molecular weight liquid crystal polyester having high heat resistance, strength and rigidity with satisfactory operability by this production method. The melt polymerization may be performed in the presence of a catalyst, and examples of the catalyst include metal compounds such as magnesium acetate, stannous acetate, tetrabutyl titanate, lead acetate, sodium acetate, potassium acetate and antimony trioxide; and nitrogen-containing heterocyclic compounds such as 4-(dimethylamino)pyridine and 1-methylimidazole. Among these compounds, nitrogen-containing heterocyclic compounds are preferable.

The flow initiation temperature of the liquid crystal polyester is preferably 250° C. or higher, more preferably from 250 to 350° C., and still more preferably from 260 to 330° C. When the flow initiation temperature becomes higher, heat resistance, strength and rigidity of the liquid crystal polyester are improved. However, when the flow initiation temperature is too high, solubility in a solvent may sometimes decrease or viscosity of the below-mentioned liquid composition may sometimes increase.

The flow initiation temperature is also called a flow temperature and means a temperature at which a viscosity becomes 4,800 Pa·s (48,000 poise) when a liquid crystal polyester is melted while heating at a heating rate of 4° C./min under a load of 9.8 MPa (100 kg/cm²) and extruded through a nozzle having an inner diameter of 1 mm and a length of 10 mm using a capillary rheometer, and the flow initiation temperature serves as an index indicating a molecular weight of the liquid crystal polyester (see “Liquid Crystal Polymer Synthesis, Molding, and Application” edited by Naoyuki Koide, page 95, published by CMC on Jun. 5, 1987).

The glass cloth according to the present invention is a sheet which is mainly made of a glass fiber. The glass fiber may be surface-treated with coupling agents such as an aminosilane-based coupling agent, an epoxysilane-based coupling agent and a titanate-based coupling agent.

The glass cloth may be any of a textile fabric (woven fabric), a knitted fabric and a nonwoven fabric. Among these fabrics, a textile fabric is preferable since dimensional stability of the below-mentioned liquid crystal polyester insulating base material is likely to be improved.

Examples of the method for producing a glass cloth include a method for producing a nonwoven fabric, which includes the steps of dispersing a fiber as a raw material in water, optionally adding a sizing agent such as an acrylic resin, and subjecting the obtained dispersion to papermaking using a paper machine, followed by drying; and a method for producing a textile fabric from a fiber as a raw material using a known weaving machine.

Examples of the weave of a fiber include plain weave, satin weave, twill weave and mat weave. The weave density is preferably from 10 to 100 yarns/25 mm. The mass per unit area of the glass cloth is preferably from 10 to 300 g/m².

The glass cloth may also be a commercially available product. Examples of easily commercially available product include glass cloths manufactured by Asahi Kasei E-materials Corporation, Unitika Ltd., NITTOBO MATERIALS CO., LTD., or Arisawa Manufacturing Co., LTD.

The thickness of one glass cloth according to the present invention is from 5 to 2.5 μm, and preferably from 8 to 18 μm. When the thickness is 5 μm or more, dimensional stability of the laminate is remarkably improved. When the thickness is 25 μm or less, repeated flexibility of the laminate is remarkably improved. Particularly, when the thickness is from 8 to 18 μm, repeated flexibility of the laminate is largely improved.

The insulating base material according to the present invention can be produced by impregnating a glass cloth with a liquid composition containing a liquid crystal polyester and a solvent, preferably a liquid composition prepared by dissolving a liquid crystal polyester in a solvent, and removing the solvent.

The solvent is preferably a solvent capable of dissolving a liquid crystal polyester to be used, for example, a solvent capable of dissolving in the concentration of 1% by mass or more (mass of liquid crystal polyester×100/total mass of liquid crystal polyester and solvent) at 50° C.

Examples of the solvent include halogenated hydrocarbons such as dichloromethane, chloroform, 1,2-dichloroethane, 1,1,2,2-tetrachloroethane and o-dichlorobenzene; halogenated phenols such as p-chlorophenol, pentachlorophenol and pentafluorophenol; ethers such as diethylether, tetrahydrofuran and 1,4-dioxane; ketones such as acetone and cyclohexanone; esters such as ethyl acetate and γ-butyrolactone; carbonates such as ethylene carbonate and propylene carbonate; amines such as triethylamine; nitrogen-containing heterocyclic aromatic compounds such as pyridine; nitriles such as acetonitrile and succinonitrile; amide-based compounds (compounds having an amide bond) such as N,N-dimethylformamide, N,N-dimethylacetamide and N-methylpyrrolidone (N-methyl-2-pyrrolidone); urea compounds such as tetramethylurea; nitro compounds such as nitromethane and nitrobenzene; sulfur compounds such as dimethyl sulfoxide and sulfolane; phosphorus compounds such as hexamethylphosphoric acid amide and tri-n-butylphosphoric acid; and two or more combinations thereof.

The solvent is preferably a solvent containing, as a main component, an aprotic compound, and particularly an aprotic compound having no halogen atom, from the viewpoint of easily handling because of low corrosiveness. The content of the aprotic compound is preferably from 50 to 100% by mass, more preferably from 70 to 100% by mass, and still more preferably from 90 to 100% by mass, based on 100% by mass of the entire solvent. The aprotic compound is preferably an amide-based compound such as N,N-dimethylformamide, N,N-dimethylacetamide or N-methylpyrrolidone since it easily dissolves a liquid crystal polyester.

The solvent is preferably a solvent containing, as a main component, a compound of a dipole moment of 3 to 5, from the viewpoint of easily dissolving a liquid crystal polyester. The content of the compound is preferably from 50 to 100% by mass, more preferably from 70 to 100% by mass, and still more preferably from 90 to 100% by mass, based on 100% by mass of the entire solvent. Accordingly, the solvent is more preferably the above-mentioned aprotic compound in which a dipole moment is from 3 to 5.

The solvent is preferably a solvent containing, as a main component, a compound having a boiling point of 220° C. or lower from the viewpoint of easily dissolving a liquid crystal polyester. The content of the compound is preferably from 50 to 100% by mass, more preferably from 70 to 100% by mass, and still more preferably from 90 to 100% by mass, based on 100% by mass of the entire solvent. Accordingly, the solvent is more preferably the above-mentioned aprotic compound in which a boiling point at 1 atm is 220° C. or lower.

The content of the liquid crystal polyester in the liquid composition is preferably from 5 to 60% by mass, more preferably from 10 to 50% by mass, and still more preferably from 15 to 45% by mass, based on 100% by mass of the total amount of the liquid crystal polyester and the solvent. The content is adjusted so that a liquid composition having desired viscosity is obtained.

The liquid composition may contain one, or a combination of two or more of other components such as a filler, an additive, and a resin other than the liquid crystal polyester.

Examples of the filler include inorganic fillers such as silica, alumina, titanium oxide, barium titanate, strontium titanate, aluminum hydroxide and calcium carbonate; and organic fillers such as a cured epoxy resin, a cross-linked benzoguanamine resin and a cross-linked acrylic resin. The content of the filler is preferably from 0 to 100 parts by weight based on 100 parts by weight of the liquid crystal polyester.

Examples of the additive include a leveling agent, a defoamer, an antioxidant, an ultraviolet absorber, a flame retardant and a colorant. The content of the additive is preferably from 0 to 5 parts by weight based on 100 parts by weight of the liquid crystal polyester.

Examples of the resin other than the liquid crystal polyester include thermoplastic resins such as polypropylene, polyamide, polyester other than the liquid crystal polyester, polyphenylene sulfide, polyetherketone, polycarbonate, polyethersulfone, polyphenyleneether and polyetherimide; and thermosetting resins such as a phenol resin, an epoxy resin, a polyimide resin and a cyanate resin. The content of the resin other than the liquid crystal polyester is preferably from 0 to 20 parts by weight based on 100 parts by weight of the liquid crystal polyester.

The liquid composition can be prepared by mixing a liquid crystal polyester, a solvent and other optional components, collectively or in an appropriate order. When the other component is a filler, the liquid composition is preferably prepared by a method including the steps of dissolving a liquid crystal polyester in a solvent to obtain a liquid crystal polyester solution, and dispersing a filler in the liquid crystal polyester solution.

Examples of the method of impregnating a glass cloth with a liquid composition include a method in which a glass cloth is dipped in a liquid composition in a dipping vessel. The amount of the liquid crystal polyester to be adhered on the glass cloth can be easily controlled by appropriately adjusting (1) the content of a liquid crystal polyester in a liquid composition, (2) a dipping time, and (3) a rate of pulling up a glass cloth from a dipping vessel.

There is no particular limitation on the method of removing a solvent from the glass cloth impregnated with the liquid composition. From the viewpoint of simplicity of a removal operation, a method of evaporating the solvent is preferable. Examples, of the evaporation method include an evaporation method by heating, an evaporation method under reduced pressure, an evaporation method by ventilation, and a combination of two or more of these methods.

In the evaporation method by heating, the heating temperature is preferably 50° C. or higher, and more preferably 80° C. or higher. The heating conditions of this method may be set to the same conditions as in the case of producing a film from a liquid crystal polyester.

The impregnation amount of the liquid crystal polyester in an insulating base material obtained by removing the solvent is preferably from 50 to 90% by mass, and more preferably from 60 to 85% by mass, based on 100% by mass of the total amount of the insulating base material.

The insulating base material obtained by removing the solvent is preferably heated so as to improve heat resistance of the insulating base material by increasing the molecular weight of the liquid crystal polyester with which the insulating base material is impregnated.

Such heating is preferably performed under an atmosphere of an inert gas such as a nitrogen gas. The heating temperature is preferably from 240 to 330° C., more preferably from 250 to 330° C., and still more preferably from 260 to 320° C. When the heating temperature is 240° C. or higher, heat resistance of the insulating base material is more improved. When the heating temperature is 330° C. or lower, productivity of the insulating base material is more improved.

While the insulating layer according to the present invention is an insulating layer of one insulating base material or plural insulating base materials laid one upon another, an insulating layer of one insulating base material is preferable. There is no particular limitation on the number of insulating base materials in the insulating layer of plural insulating base materials which are laid one upon another, and the number of insulating base materials may be two or more. Plural insulating base materials are insulating base materials which are the same entirely or the same partially, or different entirely. Examples of the method for producing plural insulating base materials laid one upon another include a method including the step (1) of laying plural insulating base materials one upon another in the thickness direction, and the step (2) of integrating plural insulating base materials laid one upon another by mutually melt-bonding through a hot press.

The thickness of the insulating layer according to the present invention is preferably 100 μm or less, more preferably 80 μm or less, and still more preferably 60 μm or less. When the thickness is 100 μm or less, repeated flexibility of the insulating layer is more improved.

The method for evaluation of repeated flexibility of the insulating layer includes a method in which evaluation is performed based on the number of bends (hereinafter referred to as “the number of bends until fracture”) when the insulating layer is repeatedly bent until fracture. Bending conditions are as follows: (1) a bending angle is from 130 to 140° (2) a curvature radius of a bent surface is from 0.35 to 0.45 mm, (3) a bending tension is from 4.5 to 5.5 N, and (4) a bending rate is from 170 to 180 times per minute. The number of bends until fracture of the insulating layer according to the present invention is preferably 5,000 times or more, more preferably 7,000 or more, and still more preferably 10,000 times or more.

The method for evaluation of dimensional stability at high temperature of the insulating layer includes a method in which evaluation is performed based on linear expansion coefficient in a surface direction when the insulating layer is heated to high temperature of 200 to 250° C. The linear expansion coefficient of the insulating layer according to the present invention is preferably 70 ppm/° C. or less, more preferably 50 ppm/° C. or less, and still more preferably 30 ppm/° C. or less.

The material of the metal layer according to the present invention is preferably copper, aluminum, silver, or an alloy containing one or more metals selected from them. Among these materials, copper or a copper alloy is preferable from the viewpoint of excellent conductivity and low costs. The metal layer is preferably a metal layer made of a metal foil, and more preferably a metal layer made of a copper foil, from the viewpoint of ease of handling, simplicity of formation, and excellent economical efficiency. In the case where the metal layer is provided on both surfaces of the insulating layer, the material of two metal layers is the same or different.

The thickness of the metal layer is preferably from 1 to 70 μm, more preferably from 3 to 35 μm, and still more preferably from 5 to 18 μm.

Examples of the method of providing the metal layer include (1) a method in which a metal foil is melt-bonded on a surface of an insulating layer by hot pressing, (2) a method in which a metal foil is adhered on a surface of an insulating layer using an adhesive, (3) a method in which a surface of an insulating layer is plated with metal, and (4) a method in which a surface of an insulating layer is coated with a metal powder or metal particles by a screen printing method or a sputtering method.

Hot pressing of the above method (1) is preferably performed under reduced pressure of 0.5 kPa or less. The heating temperature may be a temperature which is lower than a decomposition temperature of the liquid crystal polyester to be used, and preferably a temperature which is at least 30° C. lower than the decomposition temperature. The decomposition temperature can be measured by a known technique such as thermogravimetric analysis. The pressing pressure is preferably from 1 to 30 MPa, and the pressing time is preferably from 10 to 60 minutes.

In the case where the insulating layer includes plural insulating base materials laid one upon another, the laminate of the present invention may be produced by arranging all insulating base materials laid one upon another, and arranging a metal foil on one or both outer surface(s) thereof, followed by hot pressing of the method (1). This production method is a method capable of simultaneously performing the production of the insulating layer and the lamination of the metal layer.

The plating method of the method (3) is preferable in the case of providing the metal layer using a metal powder or metal particles. An electroless plating method or an electroplating method is more preferable. The obtained laminate is preferably heated so as to improve characteristics of the thus formed metal layer. The heating conditions may be the same as in hot pressing of the method (1).

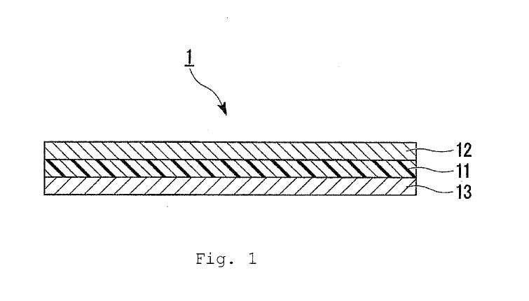

FIG. 1 is a schematic sectional view illustrating an embodiment of a laminate of the present invention. A laminate 1 includes an insulating layer 11 made of one insulating base material or plural insulating base materials laid one upon another, a metal layer 12 provided on one surface of the insulating base material, and a metal layer 13 provided on the other surface. The laminate of the present invention may not include any one of the metal layers 12 and 13, as a matter of course.

The laminate of the present invention can be preferably used as a printed wiring board as it is by forming a predetermined wiring pattern on a metal layer thereof, or in a laminated form by optionally laminating two or more of the laminates. From the viewpoint of flexibility, one laminate with a wiring pattern formed thereon is preferably used as a printed wiring board.

The laminate of the present invention is (1) excellent in repeated flexibility in spite of the fact that an insulating layer thereof includes an insulating base material using only a glass cloth as a cloth, and is also (2) excellent in dimensional stability at high temperature since the insulating base material is impregnated with a liquid crystal polyester, and thus (3) the laminate is extremely useful as an electronic substrate material.

### EXAMPLES

While the present invention has been descried by way of Examples, the present invention is not limited to these Examples.

### Production Example 1

### (1) Production of Liquid Crystal Polyester

In a reactor equipped with a stirrer, a torque meter, a nitrogen gas introducing tube, a thermometer and a reflux condenser, 1,976 g (10.5 mol) of 6-hydroxy-2-naphthoic acid, 1,474 g (9.75 mol) of 4-hydroxyacetoanilide, 1,620 g (9.75 mol) of isophthalic acid and 2,374 g (23.25 mol) of acetic anhydride were charged. After sufficiently replacing the gas in the reactor by a nitrogen gas, the temperature was raised from room temperature to 150° C. over 15 minutes while stirring under a nitrogen gas flow, and the mixture was refluxed at 150° C. for 3 hours.

While distilling oft the by-produced acetic acid and the unreacted acetic anhydride, the temperature was raised from 150° C. to 300° C. over 2 hours and 50 minutes and, after maintaining at 300° C. for 1 hour, the reaction mixture was taken out from the reactor. The reaction mixture was cooled to room temperature and the obtained solid matter was crushed by a crusher to obtain a powdered prepolymer. The prepolymer showed a flow initiation temperature of 235° C. The temperature was raised from room temperature to 223° C. over 6 hours in a nitrogen gas atmosphere and solid phase polymerization of the prepolymer was carried out at 223° C. for 3 hours, followed by cooling to obtain a powdered liquid crystal polyester. The liquid crystal polyester showed a flow initiation temperature of 270° C.

### (2) Production of Liquid Composition

The obtained liquid crystal polyester (2,200 g) was added to N,N-dimethylacetamide (solvent) (7,800 g), followed by heating at 100° C. for 2 hours to obtain a liquid composition in the form of a solution. This liquid composition in the form of a solution showed a viscosity of 0.2 Pa·s (200 cP) at 23° C. as a result of the measurement.

Using a flow tester (Model CFT-500, manufactured by Shimadzu Corporation), the above flow initiation temperature was measured by the following procedure. That is, about 2 g of a liquid crystal polyester was filled in a cylinder with a die including a nozzle having an inner diameter 1 mm and a length of 10 mm attached thereto, and the liquid crystal polyester was extruded through the nozzle while melting at a rate of 4° C./minute under a load of 9.8 MPa (100 kg/cm²), and then the temperature at which the liquid crystal polyester showed a viscosity of 4,800 Pa·s (48,000 poise) was measured.

Using a B type viscometer, Model TVL-20, manufactured by TOKI SANGYO Co., Ltd., the above viscosity was measured by a No. 21 rotor at a rotation speed of 5 rpm.

### Example 1

A 10 μm thick glass cloth (Grade 1000) manufactured by Asahi Kasei E-materials Corporation was dipped in the liquid composition obtained in Production Example 1 at room temperature for 1 minute. After evaporating a solvent by a hot air dryer at a setting temperature of 160° C., heating was performed under a nitrogen gas atmosphere, at 290° C. for 3 hours using a hot air dryer to obtain a 43 μm thick insulating base material. The impregnation amount of a liquid crystal polyester in the insulating base material was about 84.5% by mass based on 100% by mass of the total amount of the insulating base material.

A 18 μm thick copper foil (3EC-VLP) manufactured by MITSUI MINING & SMELTING CO., LTD. was placed on each of both surfaces of one insulating base material. Hot pressing was applied from both surface sides under the conditions of a maximum pressure of 5.0 MPa, a retention temperature of 340° C. and a retention time of 30 minutes using a high-temperature vacuum press machine (KVHC-PRESS, 300 mm in length, 300 mm in width) manufactured by KITAGAWA SEIKI Co., Ltd. to obtain a laminate.

The linear expansion coefficient (indicator of dimensional stability) of an insulating layer of this laminate was 13 ppm/° C., and the number of bends until fracture (indicator of repeated flexibility) was 12,060 times. It was confirmed that the thickness of the glass cloth of the laminate is the same as the original thickness (10 μm). The results are shown in Table 1.

The above linear expansion coefficient was measured by a method of the following procedure.

(1) Using a ferric chloride solution (40° Baume) manufactured by Kida Co., Ltd., the entire copper layer was removed from both surfaces of a laminate to obtain an insulating layer.
(2) The linear expansion coefficient in a facial direction of the insulating layer was measured at a temperature within a range from 200 to 250° C. under the conditions of 1st scan in accordance with JIS C6481 “Method for Testing Copper Clad Laminate for Printed Wiring Board” using Thermal Analysis System (TMA-120) manufactured by Seiko Instruments Inc.

The above number of bends until fracture was measured by a method of the following procedure.

(1) Using a ferric chloride solution (40° Baume) manufactured by Kida Co., Ltd., the entire copper layer was removed from both surfaces of a laminate to obtain an insulating layer.
(2) Using folding endurance testing machine (MIT-D) manufactured by Toyo Seiki Seisaku-sho, LTD., the insulating layer was repeatedly bent under the conditions of (i) a bending angle of 135°, (ii) a curvature radius of a bent surface of 0.38 mm, (iii) a bending tension of 4.9 N, and (iv) a bending rate of 175 times per minute, and the number of times until fracture was determined as the number of bends until fracture.

### Example 2

In the same manner as in Example 1, except that the 10 μm thick glass cloth was changed to a 13 μm thick glass cloth (Grade 1010) manufactured by Asahi Kasei E-materials Corporation, a laminate was obtained. The impregnation amount of a liquid crystal polyester in the insulating base material was about 74.0% by mass based on 100% by mass of the total amount of the insulating base material. It was confirmed that the thickness of the glass cloth of the laminate was the same as the original thickness (13 μm). The results are shown in Table 1.

### Comparative Example 1

In the same manner as in Example 1, except that the 10 μm thick glass cloth was changed to a 45 μm thick glass cloth manufactured by Unitika Ltd., a laminate was obtained. The impregnation amount of a liquid crystal polyester in the insulating base material was about 55% by mass based on 100% by mass of the total amount of the insulating base material. It was confirmed that the thickness of the glass cloth of the laminate was the same as the original thickness (45 μm). The results are shown in Table 1.

### Comparative Example 2

In the same manner as in Example 1, except that the 10 μm thick glass cloth was changed to a 30 μm thick glass cloth (Grade 1035) manufactured by Asahi Kasei E-materials Corporation, a laminate was obtained. The impregnation amount of a liquid crystal polyester in the insulating base material was about 64% by mass based on 100% by mass of the total amount of the insulating base material. It was confirmed that the thickness of the glass cloth of the laminate was the same as the original thickness (30 μm). The results are shown in Table 1.

### Comparative Example 3

In the same manner as in Example 1, except that the 10 μm thick glass cloth was changed to a 28 μm thick glass cloth (Grade 1037) manufactured by Asahi Kasei E-materials Corporation, a laminate was obtained. The impregnation amount of a liquid crystal polyester in the insulating base material was about 65% by mass based on 100% by mass of the total amount of the insulating base material. It was confirmed that the thickness of the glass cloth of the laminate was the same as the original thickness (30 μm). The results are shown in Table 1.

### Comparative Example 4

A 18 μm thick electrolyte copper foil (3EC-VLP) manufactured by MITSUI MINING & SMELTING CO., LTD. was mounted to Auto Film Applicator, Model I, manufactured by TESTER SANGYO CO., LTD. The liquid composition obtained in Production Example 1 was applied on a roughened surface of this copper foil by setting a film applicator with a micrometer manufactured by SHEEN Corp. to 450 μm to produce a two-layered material made of a copper foil and a liquid composition.

This two-layered material was heated in a ventilation oven at 100° C. for 10 minutes, thereby transpirating a solvent in the liquid composition to obtain a dried two-layered material. After raising the temperature from 30° C. to 290° C. at a temperature raising rate of 3.2° C./minute in a hot air oven under a nitrogen gas atmosphere, the dried two-layered material was heated at 290° C. for 3 hours. The two-layered material was left standing to cool to room temperature to obtain a 43 μm thick two-layered material including one liquid polyester film (insulating layer) and a copper layer provided on one surface of the insulating layer.

A 18 μm thick electrolyte copper foil (3EC-VLP) manufactured by MITSUI MINING & SMELTING CO., LTD. was placed on the liquid crystal polyester film of this two-layered material. Hot pressing was applied from both surface sides under the conditions of a maximum pressure of 5.0 MPa, a retention temperature of 340° C. and a retention time of 30 minutes using a high-temperature vacuum press machine (KVHC-PRESS) measuring 300 mm in length and 300 mm in width manufactured by KITAGAWA SEIKI Co., Ltd., thereby integrating the respective layers to obtain a laminate including one insulating layer and a copper layer provided on both surfaces of the insulating layer. The results are shown in Table 1.

TABLE 1

| | | | Linear | Number of |
|---|---|---|---|---|
| | Thickness of | Thickness of | expansion | bends until |
| | glass cloth | insulating | coefficient | fracture |
| | (μm) | layer (μm) | (ppm/° C.) | (times) |
| Example 1 | 10 | 43 | 13 | 12060 |
| Example 2 | 13 | 34 | 13 | 14520 |
| Comparative | 45 | 60 | 6 | 118 |
| Example 1 | | | | |
| Comparative | 30 | 51 | 20 | 704 |
| Example 2 | | | | |
| Comparative | 28 | 42 | 17 | 453 |
| Example 3 | | | | |
| Comparative | not used | 43 | 833 | 1330 |
| Example 4 | | | | |

Based on the above results, remarkably excellent effects of the present invention are recognized as mentioned below.

(1) The insulating layers of the laminates of Examples 1 and 2, in Which the thickness of the glass cloth satisfies a range of 5 to 25 μm according to the present invention, have excellent dimensional stability and repeated flexibility.
(2) The insulating layers of the laminates of Comparative Examples 1 to 3, in which the thickness of the glass cloth is more than 25 μm, have excellent dimensional stability, but are drastically inferior in repeated flexibility.
(3) The insulating layer of the laminate of Comparative Example 4, in which the insulating layer includes no glass cloth, is inferior in both dimensional stability and repeated flexibility. Particularly, the insulating layer is drastically inferior in dimensional stability.

What is claimed is:

1. A laminate comprising:
an insulating layer including one insulating base material or plural insulating base materials laid one upon another, the base material being obtained by impregnating a glass cloth having a thickness of 5 to 25 μm with a liquid crystal polyester; and
a metal layer provided on one surface or both surfaces of the insulating layer.

2. The laminate according to claim 1, wherein the insulating layer includes one insulating base material.

3. The laminate according to claim 1, wherein the liquid crystal polyester is a liquid crystal polyester comprising 30 to 50 mol % of a repeating unit represented by the following formula (1), 25 to 35 mol % of a repeating unit represented by the following formula (2), and 25 to 35 mol % of a repeating unit represented by the following formula (3), provided that the total of the repeating units represented by the formulas (1), (2) and (3) is 100 mol %:
—O—Ar¹—CO— (1)
—CO—Ar²—CO— (2)
—X—Ar³—Y— (3)
—Ar⁴—Z—Ar⁵— (4)
wherein Ar¹is a phenylene group, a naphthylene group, or a biphenylylene group; Ar² and Ar³ each independently represent phenylene group, a naphthylene group, biphenylylene group, or a group represented by the formula (4); X and Y each independently represent an oxygen atom or an imino group; Ar⁴ and Ar⁵ each independently represent a phenylene group or a naphthylene group;
Z is an oxygen atom, a sulfur atom, a carbonyl group, a sulfonyl group, or an alkylidene group; and one or more hydrogen atom(s) in Ar¹, Ar² or Ar³, each independently may be substituted with a halogen atom, an alkyl group, or an aryl group.

4. The laminate according to claim wherein X and/or Y is/are imino group(s).

5. The laminate according to claim 3, wherein Ar¹ is a 1,4-phenylene group or a 2,6-naphthylene group, Ar² is a 1,4-phenylene group, a 1,3-phenylene group, or a 2,6-naphthylene group, Ar³ is a 1,4-phenylene group, one of X and Y is an oxygen atom, and the other one is an imino group.
